(19) United States
(12) Patent Application Publication
(10) Pub. No.: US 2021/0073976 A1
(43) Pub. Date: Mar. 11, 2021

(54) WAFER INSPECTION METHODS AND SYSTEMS

(71) Applicant: Carl Zeiss SMT GmbH, Oberkochen (DE)

(72) Inventors: Jagdish Chandra Saraswatula, Singapore (SG); Philipp Huethwohl, Ulm (DE)

(21) Appl. No.: 16/564,833

(22) Filed: Sep. 9, 2019

(51) Int. Cl. G06T 7/00; G06T 7/136

(52) U.S. Cl. CPC G06T 7/0006; G06T 7/136; G06T 2207/30148; G06T 2207/10116; G06T 2207/10061

(57) ABSTRACT

Wafer inspection methods and systems include converting an acquired image to a polygonal chain representation. The polygonal chain representation is converted to feature vectors. The feature vectors are compared to further feature vectors obtained based on design data.

### FIELD

The disclosure relates to wafer inspection methods and systems.

### BACKGROUND

In general, semiconductor structures are built with minimum structure sizes or critical dimensions of down to about 5 nanometers, and devices with smaller critical dimensions are being developed. The fabrication of such semiconductor structures may involve about 1000 fabrication steps, starting with a blank wafer, to form an array of semiconductor dies, each semiconductor die including the semiconductor structures. The fabrication steps can include, for example, about 100 lithography steps. In modern manufacturing lines, up to 200 wafers may pass each lithography step per hour.

In order to obtain a high yield of semiconductor structures of close to 100%, it is typically desirable to closely monitor variations in any fabrication step that may indicate process variations leading to defects. Therefore, high-speed in-line metrology is used between different fabrication steps or is integrated into the fabrication steps. This metrology is sometimes also referred to as wafer inspection. Metrology tools are used to detect indications of process variations or defect candidates within a structure after specified fabrication step. Typical silicon wafers used in manufacturing of semiconductor structures have diameters of up to 12 inches (300 mm). With the small structure sizes, defect candidates of the order of the critical dimensions are desirably identified in a very large area in a short time.

For wafer inspection, usually some kind of image of the wafer surface is acquired, using techniques like scanning electron microscopy (SEM) or x-ray diffraction. Given the large area of the wafer compared to the feature size, this results in huge amounts of data to be analyzed.

Some approaches to analyze these huge amounts of data include the use of machine learning techniques, but these present various challenges. In particular, machine learning techniques typically involve samples and time for training. Also, while object detection algorithms have been used for various applications, for example for self driving cars or facial recognition, applying such algorithms to wafer inspections presents a challenge.

### SUMMARY

The disclosure seeks to provide wafer inspection methods and systems which help to inspect a plurality of wafers in short time even with small feature sizes on large wafers.

In a general aspect, a method for wafer inspection includes: acquiring an image of a processed wafer; converting the image to a polygonal chain representation; converting the polygonal chain representation to a feature vector list; comparing the feature vector list to a further feature vector list obtained based on reference data for the wafer; and determining defects in the wafer based on the comparison.

A processed wafer as used herein, may refer to a partially processed or fully processed wafer, or, in other words, a wafer in any stage during or after the front-end processing of the wafer. By converting the image into a polygonal chain representation and then converting the same to a feature vector list, a fast comparison with feature vectors based on design data is possible to detect defects. Moreover, as the design is used as reference data, new defect types of patterns can be easily detected.

Acquiring the image may include acquiring the image by multiple beam-scanning electron microscopy. Multi-beam scanning electron microscopy allows to obtain high resolution images in short time.

The polygonal chain representation may include closed polygonal chains, for example only closed polygonal chains.

The feature vector list may include one or more of convex corners, concave corners, edges and line ends.

Converting to a polygonal chain representation may include comparing image elements of the acquired image to a threshold.

Converting the acquired image to a polygonal chain representation may also include performing a contour extraction, performing a corner detection or performing a line end extension.

Using such image processing techniques allows for an efficient processing.

The method may further include converting the reference data to the further feature vector list.

Converting the reference data to the further feature vector list may include aligning the reference data to the acquired image or registering the reference data with the acquired image. In this way, based on the design data a reference fitting the acquired image may be obtained. Aligning the reference data to the acquired image or registering the reference data with the acquired image may be performed by modifying (e.g. performing a transformation like a coordinate transformation, a rotation, a translation or a size transformation) the reference data, the acquired image or both.

The reference data may be selected form the group consisting of design data, a reference wafer and a reference chip.

Converting one or more of converting the image to a polygonal chain representation, converting the polygonal chain representation to a feature vector list, and the reference data to the further feature list may be based on machine learning.

Each of the one or more of converting the image to a polygonal chain representation, converting the polygonal chain representation to a feature vector list, and the reference data to the further feature list may alternatively or additionally be based on an image analysis.

In a general aspect, a wafer inspection system includes an image acquisition device configured to acquire an image of a processed wafer, and an evaluation device. The evaluation device is configured to: convert the image to a polygonal chain representation; convert the polygonal chain representation to a feature vector list; compare the feature vector list to a further feature vector list obtained based on reference data for the wafer; and determine defects in the wafer based on the comparison.

The image acquisition system may include a multi-beam scanning electron microscope.

The device, in particular the evaluation device, may be configured to perform any of the methods discussed above.

In a general aspect, a method includes: converting an image of a processed wafer to a polygonal chain representation; converting the polygonal chain representation to a first feature vector list; comparing the first feature vector list to a second feature vector list obtained based on reference data for the wafer; and determining defects in the wafer based on the comparison.

In a general aspect, a method includes: converting a polygonal chain representation of an image of a processed wafer to a first feature vector list; comparing the first feature vector list to a second feature vector list obtained based on reference data for the wafer; and determining defects in the wafer based on the comparison.

In a general aspect, a system includes a first device configured to acquire an image of a processed wafer. The system also includes a second device configured to: convert the acquired image to a polygonal chain representation; convert the polygonal chain representation to a first feature vector list; compare the first feature vector list to a second feature vector list obtained based on reference data for the wafer; and determine defects in the wafer based on the comparison

### BRIEF DESCRIPTION OF THE DRAWINGS

FIG. 1 is a chart illustrating an application environment for some embodiments.

FIG. 2 is a flowchart illustrating a method according to an embodiment.

FIG. 3 is a block diagram illustrating a system according to an embodiment.

FIGS. 4A to 4C are diagrams illustrating a conversion to a polygon chain as used in some embodiments.

FIG. 5 is a diagram for further illustrating operation according to some embodiments.

FIGS. 6A and 6B show variations of the method of FIG. 2.

### DETAILED DESCRIPTION

In the following, various embodiments will be described in detail referring to the attached drawings. These embodiments are to be understood as examples only and are not to be construed as limiting in any way.

Features from different embodiments may be combined to form further embodiments. Variations or modifications described with respect to one of the embodiments may also be applicable to other embodiments and will therefore not be described repeatedly.

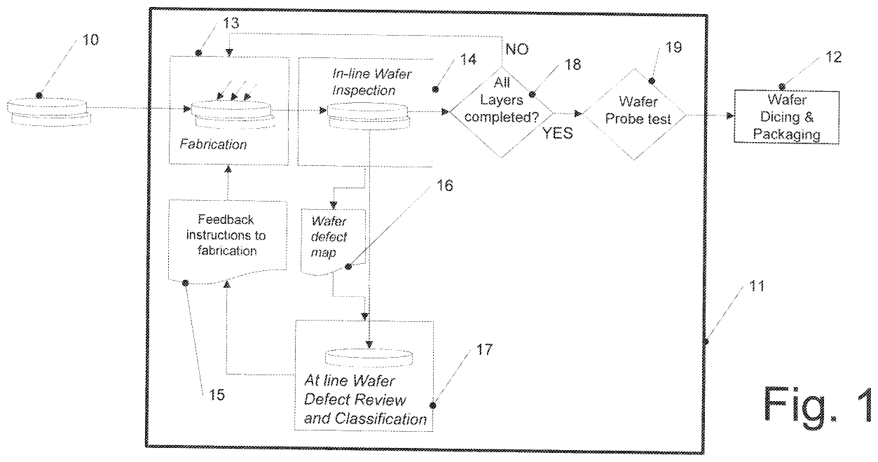

Embodiments as discussed herein may be employed for in-line metrology wafer inspection during manufacturing of semiconductor devices. An example for such a manufacturing of semiconductor devices as an application environment for various embodiments is illustrated in FIG. 1.

In FIG. 1, the manufacturing of semiconductor devices starts with blanc wafers 10. Examples for such blanc wafers 10 include silicon wafers or gallium arsenide wafers, but any semiconductor wafers or other substrates used for semiconductor device manufacturing may be used. First, the wafers 10 are subjected to a so-called front-end processing at 11. Front-end processing relates to all processing steps where structures are formed on or in the wafer, before the structures on the wafers are mechanically separated from each other. For mass production, of a plurality of equal structures is formed on the wafers, which are then separated into separate semiconductor devices. Wafers 10 in front-end processing 11 are subjected to a plurality of fabrication steps 13. Such fabrication steps may include etching, layer deposition of semiconductor layers or metal layers, diffusion or implantation, for example for doping, cleaning, wafer planarization, resist coating and resist treatment, lithography exposure etc. With these fabrication steps, structures are formed on wafers 10.

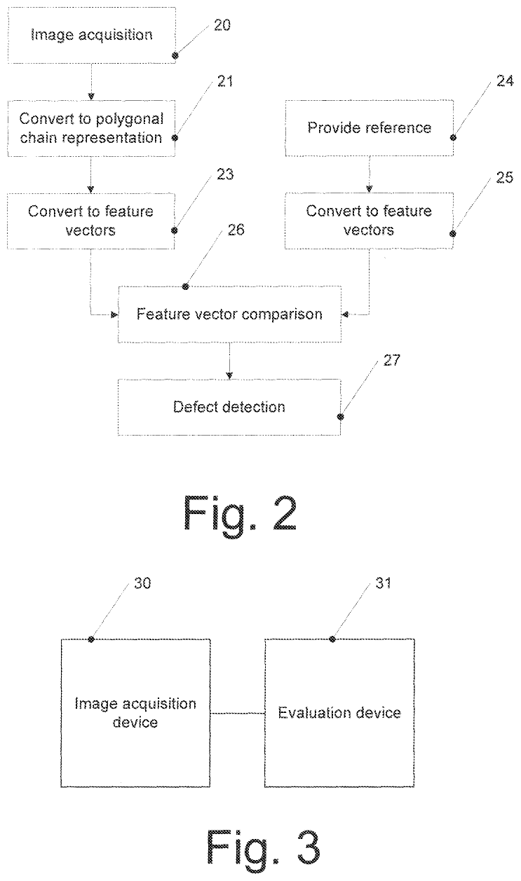

After certain fabrication steps, the wafers are subjected to in-line wafer inspection at 14. In the in-line wafer inspection, methods and devices as explained further below with reference to FIGS. 2 to 6 are used to obtain a defect map 16 of the wafer, i.e. to obtain information where on the wafer structures have not been formed as desired. Generally, such a wafer inspection may include various measurements of physical parameters such as film thickness, film uniformity, detection of foreign particles or contaminations or measuring electrical parameters, like resistance or capacitance. In embodiments as discussed further below, in particular features and dimensions of structures formed on the wafer are evaluated by acquiring an image of the wafer. These measurements may be performed directly on product wafers, i.e. on wafers used to manufacture semiconductor devices for sale, either directly or using specific test structure, or alternatively on specific non-functional monitor wafers (also referred to as dummy wafers). Specifically designed test structures are also known as process control monitors (PCMs). In addition to these measurements, some measurements are actually performed “in situ,” i.e. during a fabrication step.

If the defect map of the wafer indicates defects, i.e. when defects are detected, the wafers where the defects are detected may be provided to an at-line wafer defect review and classification at 17. “At-line” indicates that the wafers in this case are taken out of the usual production process for further inspection. In particular, in the review at 17, the locations identified in wafer defect map may be reviewed in order to verify and classify the indications of process variations or defects. The determination of the presence or absence of defects at 17 may be carried out by comparing the image data to data previously gathered for a similar section of another object (die-to-die), or it may be carried out by comparison to a corresponding portion of a reference database (die-to-database) or a design data (die-to-CAD). All data may be handled and controlled in databases, including defect databases forming a collection of representative defects, CAD databases collecting information about ideal or representative structures, and process recipes. As a result, at 15 feedback instructions to the fabrication may be given, for example to modify fabrication parameters to counter process variations, or also instructions for example to do maintenance due to possible malfunctioning components in a corresponding fabrication system.

These steps are repeated until at 18 all layers of the front-end processing are completed. Following this, at 19 wafer probe testing may be performed, where for example structures on the wafer are contacted electrically by probes to perform test measurements. This concludes the front-end processing.

After the front-end processing at 11, back-end processing 12 follows where the wafers are diced into separate chips, and the chips are packaged. More testing of the semiconductor devices manufactured may occur during the back-end processing 12.

As already discussed in the introductory portion, for large semiconductor wafers and small structure sizes in the in-line wafer inspection at 14, huge amount of data have to be gathered and analyzed. Embodiments discussed in the following referring to FIGS. 2 to 5 may help to implement the in-line wafer inspection at 14.

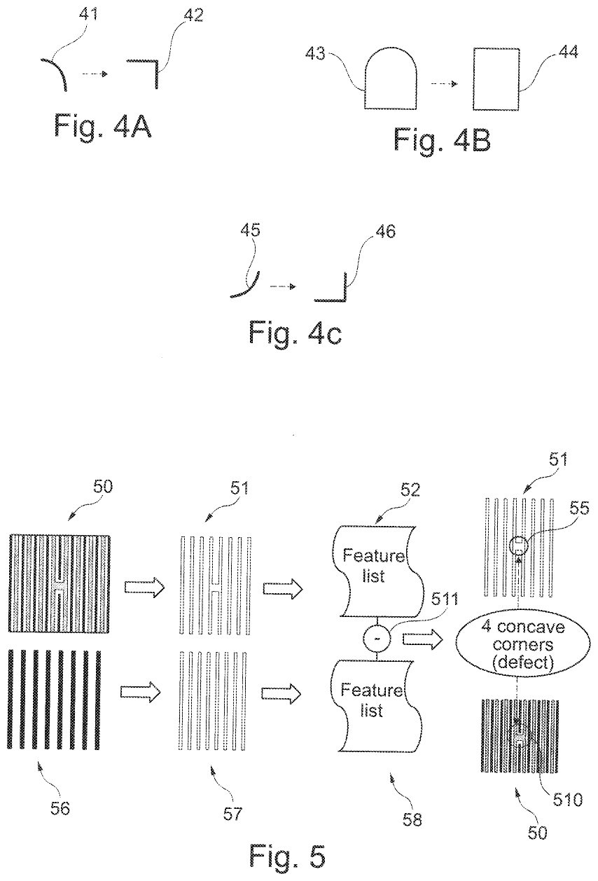

FIG. 2 is a flowchart illustrating a method according to an embodiment, and FIG. 3 shows a corresponding system, where the method may be implemented. FIGS. 4A to 4C and 5 show diagrams which will be further used for explaining the method of FIG. 2 and the system of FIG. 3.

At 20, the method includes performing an image acquisition of a wafer to be inspected. To this end, the system of FIG. 3 includes an image acquisition device. The term “image”, as used herein, is to be construed broadly and encompasses all data which may represent structures formed on the wafers in an array of image elements. The kind of imaging desired may also depend on the size of the structures on the wafer, as for smaller structures higher resolution techniques are desirable. In particular, image acquisition devices 30 may be an optic image acquisition device using light of a short wave length such as spectroscopic metrology, metrology using x-rays such as an x-ray transmission or diffraction microscope, or a device using charged particles such as a scanning electron microscope (SEM) or a focused ion beam (FIB)-microscope using electrons or other charged particles such as gallium or helium ions. These devices using charged particles are also collectively referred to as charged particle microscopes (CPM). The image is formed based on secondary particles or radiation emitted from the wafer in response to the irradiation with the primary radiation, i.e. the charged particle beams. The secondary radiation may be in the form of secondary electrons or backscattered charged particles, or electromagnetic radiation such as light or x-rays. The composition, energy and angle of the secondary radiation can be controlled by the energy of the primary radiation and is an indication of the material composition and surface quality of the wafer surface scanned.

A recent development in the field of charged particle microscopes CPM is the MSEM, a multi-beam scanning electron microscope. In an MSEM, the wafer is irradiated by an array of electron beams, including for example 80 up to 10000 electron beams, as primary radiation. Each electron beam is typically separated by a distance of between 1 and 200 micrometers from its next neighboring electron beam. For example, the MSEM can have 100 separated electron beams, arranged on a hexagonal array, with the electron beams separated by a distance of 10 μm. These electron beams are scanned in parallel over an object, forming an image patch of for example 110 μm diameter. After acquisition of the image patch, a substrate or wafer stage is moved to a next patch position and the image of the next patch is obtained by again scanning of the electron beam array. Thereby, a high resolution images with below 5 nm resolution can be formed by stitching multiple image patches together. It is also possible to acquire high resolution images for specific locations on a wafer, for example for the above mentioned PCMs or critical areas only. With an MSEM, a fast scanning of a wafer surface is possible, and therefore, it is well suitable for wafer metrology with a high throughput and with high resolution of down to few nm, for example 5 nm. The throughput may depend on resolution and the number of beamlets. For 100 beamlets, typical examples of throughput are 3.5 sq mm/min (square-millimeter per minute), or up to 10 sq mm/min. With increasing number of beamlets, e.g. with 100×100 beamlets, the throughput can go up to more than 300 sq mm/min, or even more than 500 sq mm/min, or even exceed 1000 sq mm/min.

However, uses of techniques as described herein are not limited to an MSEM as image acquisition device 30, but other image acquisition devices of high throughput, for example as described above, may also be used, as long as the resulting image has a sufficiently high resolution, i.e. a sufficiently high pixel density, to capture the smallest relevant detail, for example the smallest occurring defects or deviations from an intended structure of the wafer which should be detected by the method of FIG. 2. Such an image acquisition device might for example be an integrated array of scanning electron beam columns.

An example for an acquired image is shown in FIG. 5 bearing reference numeral 50. Here, line structures have been formed on a wafer. In the middle of image 50, a deviation from the line structure is visible.

This image is then processed further using the method of FIG. 2. To achieve this, in the system of FIG. 3, an evaluation device 31 is provided. Evaluation device 31 may be a computer or similar device having a processor programmed accordingly, for example a desktop computer, a laptop, a tablet PC or the like. In other embodiments, parts or all of the method may be implemented using specific hardware like application specific integrated circuits (ASICs) or field programmable gate arrays (FPGAs). In general, any device capable of performing the processing discussed in the following may be used.

At 21, the image acquired at 20 is processed to be converted to a polygonal chain representation. A polygonal chain is a connected series of line segments. It should be noted that in the context of the present application, such a polygonal chain may also include only a single line segment. In some case, the polygonal chain is closed, such that the last line segment of the series is connected to the first line segment. In this case, a polygon is formed. In some embodiments, only closed polygonal chains, i.e. polygons are used. For example, when designing semiconductor chip layouts, in many tools used for design only polygons are used. In such cases, what seem to be lines in a design may for example be formed by thin elongate rectangles. To match such designs, also at 21 and subsequent steps polygons may be used. However, in other embodiments also open polygonal chains may be used. For conversion to polygonal chains, the image acquired at 20 may be subjected to a series of image processing steps. In other words, shapes present in the image are processed to resemble actual polygonal chains, as they are present in a design as will be explained later.

As a first step, the image in some embodiments is subjected to a thresholding for black and white conversion to separate the foreground which is then converted to polygonal chains from the background. For example, in image 50 of FIG. 53, the threshold may be set to remove the background.

For example, the image may be provided as a greyscale image. In thresholding, the gray scale image is converted to a binary image by pixel thresholding and thereby a data reduction is achieved. After selection of a threshold value, all pixels having a gray level value which is below the selected threshold value is set to 0 (black e.g. background) and all the pixels having a gray level value which is equal to or greater than the threshold value are classified as 1 (white, e.g. foreground). Further details of thresholding may be found at https://www.geeksforgeeks.org/matlab-converting-a-grayscale-image-to-binary-image-using-thresholding/

Then, image processing techniques like contour extraction, corner detection and extension (for example to form closed polygonal chains) may be performed. Generally, various feature extraction techniques may be used, in particular polygon feature extraction techniques. An overview over feature extraction techniques may be found on the English Wikipedia page “feature extraction”, retrieved 15:18, May 16, 2019, from https://en.wikipedia.org/w/index.php?title=Feature extraction&oldid=877129337.

Examples for contour extraction may be found in Image Contour Extraction Method based on Computer Technology from Li Huanliang, 4th National Conference on Electrical, Electronics and Computer Engineering (NCEECE 2015), 1185-1189 (2016).

In this way, Manhattan polygonal chains become visible. The term “Manhattan polygonal chains” refers to polygonal chains which have only right angles. They are also referred to as rectilinear polygonal chains.

Several examples for the conversion into a polygonal chain representation, in particular a Manhattan polygonal chain representation, are shown in FIGS. 4A to 4C. In FIG. 4A, an upper round corner 41 is converted to a rectangular polygonal chain 42. In FIG. 4B, a closed shape 43 with a rounded upper part is converted to a rectangular shape 44. In FIG. 4C, a lower round corner 45 is converted to a corresponding rectangular polygonal chain 46.

In embodiments, for the conversion, contours extracted from the image are converted to the closest Manhattan polygon structure. In some embodiments, this may be achieved using image processing algorithms like contour approximation or convex hull extraction. Contour extraction approximates a contour shape to another shape with less number of vertices depending upon a specified precision. In convex hull extraction, the polygon chains are checked for convexity defects and convex forms are removed. As a result, reduced polygon chains of convex shape are extracted.

For the example image 50, the result of the conversion to a polygonal chain representation is shown at 51 in FIG. 5. Here, the vertical structures now show as vertical lines, and the deviation from the line structure in the middle of the image is converted to a rectangular polygon.

It should be noted that in embodiments this is still an image, which, however, has been processed to exhibit substantially only polygonal chain features.

Turning to FIG. 2, at 23 the method includes converting the polygonal chain representation thus obtained to a feature vector list. This means that the polygonal chains are now described in terms of their features (for example corners, lines, line ends), in particular as vectors. In other words, the image is converted into a list of features represented by vectors. The feature vectors may be extracted using feature extraction techniques like pixel tracing. Further examples for suitable techniques may be found in Dilip Kumar Prasad, “GEOMETRIC PRIMITIVE FEATURE EXTRACTION—CONCEPTS, ALGORITHMS, AND APPLICATIONS”, thesis submitted to Nanyang technological university, School of Computer Engineering, 2012.

This conversion to a feature list is illustrated in FIG. 5 by a feature list 52. This feature list may include convex corners, concave corners, edges and line ends, and in some embodiments may be limited to these elements. Each of these features may have various orientations. For the example of FIG. 5, the feature list 52 contains 16 line ends (2 for each of the 8 vertical lines), 8 vertical line edges, two horizontal lines (having two line ends and 1 line edge each) and 4 concave corners. In some embodiments, the feature vector list may be done by using a co-ordinate {x,y}, feature vector implementation. As an example, at a given coordinate, for example (25, 3700), there is a feature, for example, a line-end which we denote as LE. Thus, this entire information could be represented as {25, 3700; LE}.

As can be easily seen, by conversion to this list the amount of data may be reduced significantly compared to full image data.

Furthermore, at 24 in FIG. 2 reference data for the wafer is provided. In some embodiments, the reference data may include design data, i.e. data representing how the wafer was designed to look like in each processing stage. This may be in the form of a computer-aided design (CAD) file, for example a file in the GDSII (graphical design station/graphic data system II) format or OASIS (open artwork system interchange standard) format. This design data already uses Manhattan shapes, i.e. rectilinear polygonal chains. At 25, the reference data, e.g. design data, is converted to a feature vector list corresponding to the feature vector list resulting at 23, i.e. feature vectors for the field of view of the image acquisition at 20. To achieve this, an alignment and a registration may also be performed when generating the feature vector list at 25 to ensure a corresponding orientation (up and down, left and right) and corresponding field of view between the design data and the polygonal chain representation. It should be noted that steps 24 and 25 may have to be performed only once for each wafer design and each processing stage where the wafer inspection (14 in FIG. 1) is to be performed, i.e. the feature list generated at 25 may be used for inspection of a plurality of wafers of the same design. In other embodiments, instead of design data a fault-free wafer or chip may be used as reference data. Here, generating the feature list at 25 may be done similar to steps 20-23, i.e. by acquiring an image of the reference wafer or chip, performing a conversion to a polygonal chain representation and generating the feature vector list based on this polygonal chain representation.

An example reference wafer or chip is designated with reference numeral 56 in FIG. 5, which, as shown as 57, is converted to a polygonal chain representation which is converted to a feature list at 58. In case design data is used as reference data, the design data may already be in the form of a polygonal chain representation at 57, which is converted to a feature list at 58. In the example of FIG. 5, feature list 58 contains 16 line ends (2 for each of the 8 vertical lines) and 8 vertical line edges.

At 26 in FIG. 2, the method then includes a feature vector comparison between the feature vector list generated at 23 and the feature vectors generated at 25. As the feature vectors are provided as lists, to find differences between the lists, an easy comparison may be implemented. The differences between the lists indicate feature in the wafers that are either additional to or less than the features present in the design provided at 24.

In embodiments where the feature lists are provided using a (co-ordinate{x,y}, feature vector) implementation as discussed above, the feature vector lists generated from the design and the wafer image are aligned. Thus the comparison now becomes even easier and also may give the accurate location of the defect to nm precision in some embodiments.

For example, by the comparison symbolized by a minus at 511 in FIG. 5, the rectangular shape 55 in the polygonal representation 51 is identified as a possible defect. In particular, comparing the example feature lists 52 and 58 as explained above, four concave corners and two horizontal lines (with two line ends and one line edge each), which describes the defect.

At 27 in FIG. 2, the defects are then detected based on the result of the comparison, for example by checking the detected differences against the image acquired at 20. In this case, for example in the image 50 reproduced again the area marked with reference numeral 510 is identified as a defect. While in the simple example of FIG. 5 obviously the defect is easily derivable as a relatively small image with simple structures as shown, the method discussed may also be applied to large area images of wafers with a great plurality of different features and may allow efficient detection of defects.

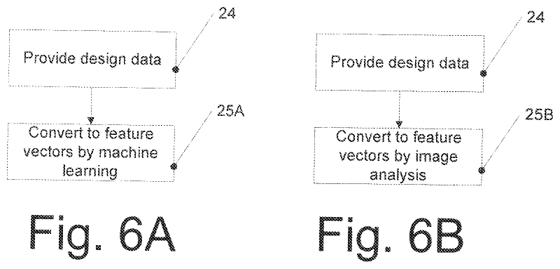

Obtaining feature vectors at 25 from the design data provided at 24 may be performed in various manners. Examples are shown in FIGS. 6A and 6B. In FIG. 6A, the conversion to feature vectors is performed by machine learning as a step 25A. Machine learning relates to techniques like numeral networks, where training data is provided in the form of examples how the design is converted to the feature vectors, and based on this training data, the system like in neural network is trained to perform the conversion. In FIG. 6B, in a step 25B conventional image analysis is used instead. It should be noted that also for steps 20 to 23, conventional image analysis, machine learning techniques or both may be used.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible program carrier for execution by, or to control the operation of, a processing device. Alternatively or in addition, the program instructions can be encoded on a propagated signal that is an artificially generated signal, e.g., a machine-generated electrical, optical, or electromagnetic signal that is generated to encode information for transmission to suitable receiver apparatus for execution by a processing device. A machine-readable medium can be a machine-readable storage device, a machine-readable storage substrate, a random or serial access memory device, or a combination of one or more of them.

The term “processing device” encompasses all kinds of apparatus, devices, and machines for processing information, including by way of example a programmable processor, a computer, or multiple processors or computers. The apparatus can include special purpose logic circuitry, e.g., an FPGA (field programmable gate array) or an ASIC (application specific integrated circuit) or RISC (reduced instruction set circuit). The apparatus can also include, in addition to hardware, code that creates an execution environment for the computer program in question, e.g., code that constitutes processor firmware, a protocol stack, an information base management system, an operating system, or a combination of one or more of them.

A computer program (which may also be referred to as a program, software, a software application, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or information (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input information and generating output. The processes and logic flows can also be performed by, and apparatus can also be implemented as, special purpose logic circuitry, e.g., an FPGA (field programmable gate array) or an ASIC (application specific integrated circuit) or RISC.

Computers suitable for the execution of a computer program include, by way of example, general or special purpose microprocessors or both, or any other kind of central processing unit. Generally, a central processing unit will receive instructions and information from a read only memory or a random access memory or both. The essential elements of a computer are a central processing unit for performing or executing instructions and one or more memory devices for storing instructions and information. Generally, a computer will also include, or be operatively coupled to receive information from or transfer information to, or both, one or more mass storage devices for storing information, e.g., magnetic, magneto optical disks, or optical disks. However, a computer need not have such devices. Moreover, a computer can be embedded in another device, e.g., a mobile telephone, a smartphone or a tablet, a touchscreen device or surface, a personal digital assistant (PDA), a mobile audio or video player, a game console, a Global Positioning System (GPS) receiver, or a portable storage device (e.g., a universal serial bus (USB) flash drive), to name just a few.

Computer readable media (e.g., one or more machine readable hardware storage devices) suitable for storing computer program instructions and information include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and (Blue Ray) DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as an information server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital information communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In another example, the server can be in the cloud via cloud computing services.

As can be seen from the above explanations, numerous variations and modifications are possible, and it is evident that the scope of the disclosure is not limited by the specific embodiments.

What is claimed is:

1. A method, comprising:
converting an image of a processed wafer to a polygonal chain representation;
converting the polygonal chain representation to a first feature vector list;
comparing the first feature vector list to a second feature vector list obtained based on reference data for the wafer; and
determining defects in the wafer based on the comparison.

2. The method of claim 1, further comprising acquiring the image.

3. The method of claim 1, further comprising using multi-beam scanning electron microscopy to acquire the image.

4. The method of claim 1, wherein the polygonal chain representation comprises closed polygonal chains.

5. The method of claim 1, wherein the first feature vector list comprises at least one member selected from the group consisting of a convex corner, a concave corner, an edge, and a line end.

6. The method of claim 1, wherein converting to the polygonal chain representation comprises comparing image elements of the image to a threshold.

7. The method of claim 1, wherein converting to the polygonal chain representation comprises performing at least one member selected from the group consisting of a contour extraction, performing a corner detection, and a line end extension.

8. The method of claim 1, further comprising converting the reference data to the second feature vector list.

9. The method of claim 8, wherein converting the reference data to the second feature vector list comprises at least one member selected from the group consisting of aligning the reference data to the acquired image, and registering the reference data with the acquired image.

10. The method of claim 1, wherein the reference data is selected form the group consisting of design data, a reference wafer and a reference chip.

11. The method of claim 1, wherein at one member selected from the group consisting of converting the image to the polygonal chain representation, converting the polygonal chain representation to the first feature vector list, and converting the reference data to the second feature list is based on machine learning.

12. The method of claim 1, wherein at one member selected from the group consisting of converting the image to the polygonal chain representation, converting the polygonal chain representation to the first feature vector list, and converting the reference data to the second feature list is based on an image analysis.

13. One or more machine-readable hardware storage devices, comprising:
instructions that are executable by one or more processing devices to perform operations comprising the method of claim 1.

14. A system, comprising:
one or more processing devices; and
one or more machine-readable hardware storage devices comprising instructions that are executable by the one or more processing devices to perform operations the method of claim 1.

15. A system, comprising:
a first device configured to acquire an image of a processed wafer; and
a second device configured to:
convert the acquired image to a polygonal chain representation;
convert the polygonal chain representation to a first feature vector list;
compare the first feature vector list to a second feature vector list obtained based on reference data for the wafer; and
determine defects in the wafer based on the comparison.

16. The system of claim 15, wherein the first device comprises a multi-beam scanning electron microscope.

17. A method, comprising:
converting a polygonal chain representation of an image of a processed wafer to a first feature vector list;
comparing the first feature vector list to a second feature vector list obtained based on reference data for the wafer; and
determining defects in the wafer based on the comparison.

19. The method of claim 18, wherein the polygonal chain representation comprises closed polygonal chains.

20. The method of claim 18, wherein the first feature vector list comprises at least one member selected from the group consisting of a convex corner, a concave corner, an edge, and a line end.
